(19) United States
(12) Patent Application Publication
(10) Pub. No.: US 2026/0166783 A1
(43) Pub. Date: Jun. 18, 2026

(54) REMEDIATION OF RECYCLED PLASTICS BY URETHANE FORMULATIONS TO ENHANCE SURFACE REFLECTIVITY

(71) Applicant: VALEO VISION, Bobigny (FR)

(72) Inventor: Robert FRAIZER, Seymour, IN (US)

(73) Assignee: VALEO VISION, Bobigny (FR)

(21) Appl. No.: 18/984,583

(22) Filed: Dec. 17, 2024

(51) Int. Cl. B29C 39/12; B29C 39/22; B29K 33/00; B29K 75/00; B29K 105/00; B29K 505/00; B29L 11/00

(52) U.S. Cl. CPC B29C 39/123; B29C 39/22; B29C 2791/002; B29K 2033/08; B29K 2075/00; B29K 2105/0085; B29K 2505/00; B29K 2995/003; B29K 2995/0073; B29K 2995/0097; B29L 2011/0083

(57) ABSTRACT

The present invention pertains to enhancing reflector component production from low-grade or recyclable plastics containing porous or irregular surfaces by using urethane-based (PUR) formulations or film coatings with the objective of enhancing the surface finish of substrate mediums, particularly for the metallization or reflective deposition of parts in automotive lighting. A reflector and lighting component product of urethane-based formulations is derived from an in-mold process, which results in enhanced substrate surface preparation for reflective material deposition and the improvement of light reflectivity performance along remediated surfaces.

### TECHNICAL FIELD

The present invention relates to enhancing the surface reflectivity of porous and rough substrates using polyurethane based (PUR) coatings for light-reflective products. More particularly, the present invention relates to improving the condition of reflective surfaces in irregular or course finish plastics for light-reflective enhancement in automotive lighting products with a coating arrangement that improves light reflective performance and control of directed light distribution.

### BACKGROUND OF THE INVENTION

In the automotive field of vehicle lighting, manufacturers are seeking to improve light reflective performance by addressing the substrate surfaces of course, porous and irregular base layers of plastic based light reflective components. Among existing problems of using lower specific gravity plastics or recycled plastics is that these plastics inherently possess course and irregular surface finishes, which renders such base plastics as not feasible as reflector components. Thus, making the step of metallizing such a base plastic material an impractical matter from the added complexity of requiring surface preparation and getting uncontrollable light scattering distribution after metallization, which renders application of these kinds of plastics not feasible without a simpler solution. Another existing problem with applied PUR materials is that the existing production of in-mold acrylic-urethane film coatings has the consequence of releasing solvents of volatile organic compounds (VOC) into the environment from the polymerization and cross-linking process and curing stages of existing methods. However the inventors have conceived systems where such base plastics exhibiting surface deficiencies can be successfully tackled with the application of polyurethane-based (PUR) compositions for light reflective purposes and products in the automotive field that can improve surface finishes for enhanced reflectivity characteristics. Polyurethane (referenced in the field as PU or PUR for abbreviated convenience) is a chemically manufactured plastic, which may be applied as a coating material.

Accordingly in the automotive field, there is a need for providing a better approach and methods to address surface defects of base reflector using resilient PUR compositions, which can facilitate a glossy surface base ideal for a metallized deposition within a precision tolerance bed that can fulfill light reflective beam performance and meet the automotive field's sought after objectives.

### SUMMARY OF THE INVENTION

Accordingly, among the objectives of the present invention is to overcome the above mentioned drawbacks in the state of the art. One objective of the present disclosure can provide an enhanced coating formulation that can process the irregular surface voids and course surfaces towards achieving a smooth or glassy finish through PUR composition applications. PUR composition applications that promote base surface gloss and smoothness to enhance beam pattern transmission and performance, facilitate light ray control, eliminate additional surface preparation processes and promote sustainability without adversely impacting the environment over the service life of designed components and products.

Another essential objective is to provide PUR-based formulations to promote substantial reductions of volatile organic compounds from production while also enhancing the light reflective performance of lighting products. An additional objective is to promote a simplified way of remediating base surfaces into consistently smooth finish through urethane-based coatings applied to lower specific gravity plastics and recycled plastics with course or irregular surface finishes that eliminate additional costs and the cumbersome surface treatment processes that attain favorable reflective surface characteristics.

Among the particulars, the present invention proposes enhancement of a product's reflectivity and appearance of lighting devices to make a beam's projection target shine brightly consistent when adopted with the vehicle's appearance. The present invention also proposes improving the lighting performance of associated products with the reflectivity enhancements beyond currently existing reflective coating formulations for production of glossy bezels or sufficiently smooth reflector finishes.

These and other objectives of the disclosure may be achieved by one or more of the following aspects. Accordingly, an embodiment of the present invention provides: a light-reflective product formed from an in-mold process comprising: a plastic substrate of an opaque medium that is configured to block light through the plastic substrate, where the plastic substrate has a number of surface imperfections described by an irregular surface as measured by a roughness value [μ] along a majority surface area [S]; a layer of urethane-based composition (PUR) applied along a majority surface area [S] of the plastic substrate that is configured to fill the number of surface imperfections for enhancing a surface smoothness by a measure of Distinctness of Image (DOI) along the majority surface area [S]; a layer of reflective material deposited over the layer of PUR-based composition; and the layer of reflective material resulting in the surface smoothness of about 78 DOI value as a surface reflection characteristic.

In an alternative embodiment of the present invention, there is provided an automotive light-reflector formed from an in-mold process comprising: a plastic substrate of an opaque substrate medium, where the plastic substrate has a number of surface imperfections described by an irregular surface as measured by a roughness value of Ra 6.5 μm; a layer of urethane-based (PUR) composition in a fully cured condition applied with a pre-determined thicknesses [T] along a majority surface area of the plastic substrate that is configured to fill the surface imperfections for enhancing the surface smoothness [μ] along the majority surface area [S]; a layer of reflective material applied with a pre-determined thickness [T] of between 7-20 microns (0.007-0.020 mm) consistently across the majority surface area of the plastic substrate resulting in a surface reflection value of at least 78 DOI consistently across the majority surface area.

A non-limiting preceding embodiment wherein the reflective material includes a metallic compound.

A non-limiting preceding embodiment wherein the reflective material includes a polymeric compound embedded with reflective particles.

A non-limiting preceding embodiment wherein the PUR-based composition can be derived from polyol and isocyanate compounds.

A non-limiting preceding embodiment wherein the number of surface imperfections encompasses one or more features of: grainy protrusions, voids, wavy forms, pitted dimples, micro inclusions, surface abrasions, porous features or surface inclusions.

A non-limiting preceding embodiment wherein the reflective layer with a predetermined thickness [T] overlays a PUR-based coating thickness value [T] of between 7-20 microns (0.007-0.020 mm) consistently across the majority surface area [S] of the plastic substrate.

A non-limiting preceding embodiment wherein the light reflective product achieves a reflectivity value of at least 82 DOI with consistency as measured across the majority surface area [S].

A non-limiting preceding embodiment wherein the number of surface imperfections reside specifically along an exterior surface of the plastic substrate on a same side as a reflecting light source.

A non-limiting preceding embodiment wherein the PUR-based composition is an acrylic-urethane (PUA) formulation.

A non-limiting preceding embodiment wherein the PUR-based composition is used in conjunction with an oligomer based formulation configured to regulate flow viscosity.

A non-limiting preceding embodiment wherein the PUR-based composition is derived from an acrylic monomer formulation of esters.

A non-limiting preceding embodiment wherein the PUR-based composition is configured to include reflective particles of a metallic compound for an alternate formulation.

A non-limiting preceding embodiment wherein the reflective layer is applied over a pre-determined thickness [T] of the PUR-based composition.

A non-limiting method embodiment of the present invention provides a method of making a light-reflective product from an in-mold process comprising: presenting a plastic substrate of an opaque medium where the plastic substrate has a number of surface imperfections as measured by a roughness value of between Ra 1.6 μm to Ra 2.5 μm (roughness scale Ra-value); applying a layer of a urethane-based composition (PUR) along a majority surface area of the plastic substrate such that the PUR-based composition fills the surface imperfections to such an extent as to achieve a surface smoothness [μ] of about Ra 0.4 μm (roughness scale Ra-value) along the majority surface area; applying a layer of reflective material with a predetermined thickness [T] over the layer of PUR-based composition; obtaining a reflectivity value range of between 82-92 DOI consistently across the majority surface area as measured by a lighting test; and removing the light-reflective product from an in-mold process and incorporating the light-reflective product into a lighting system.

A preceding method embodiment wherein the coating layer maintains the surface reflection value of at least 76 DOI.

A preceding method embodiment wherein the coating layer maintains the surface reflection value of about 78 DOI.

Variations and modifications can be made to the aforementioned structure without departing from the concepts of the present invention. And it should be appreciated that the above referenced embodiments and examples are non-limiting, as other embodiment variations can exist within the present invention, as shown and described herein. Moreover, such concepts are intended to be covered by the following claims unless these claims by their language expressly state otherwise.

### BRIEF DESCRIPTION OF DRAWINGS

The accompanying drawings that incorporate and constitute a part of the specification, illustrate various embodiments to explain these embodiments together with the description. As such, the accompanying drawings have not necessarily been drawn to scale. Any values dimensions illustrated in the accompanying graphs and figures are for illustration purposes only which may or may not represent actual or preferred values or dimensions. Where applicable, some or all features may not be illustrated to assist in the description of underlying features. In the drawings:

FIG. 1 is an illustration of existing defects along interfacial surfaces of low-gravity or low-grade plastic exhibiting irregular surface characteristics.

FIG. 2 is a depiction of smoothened surface results following a PUR coating treatment applied on an irregular surface as in FIG. 1 akin to a polished steel tool surface according to the present invention.

FIG. 3 is a cross-sectional illustration of a resultant product structure of a reflective component after application of PUR-based formulation to an irregular surface substrate according to the present invention.

FIG. 4 is an illustration of a single component in-mold PUR-based formulation process applied in remediating low-grade plastic substrates according to the present invention.

FIG. 5 is a visual depiction of a single component polyurethane-urethane (PUR) formulation system of a reflective product after thermal curing according to an embodiment of the invention.

FIG. 6 is a visual depiction of a single component acrylic-urethane (PUA) formulation system of a reflective product after thermal curing according to an alternate embodiment of the invention.

FIG. 7 illustrates a method of making polyurethane-based (PUR) coated products by remediating lower-grade irregular surface plastics into surfaces of reflective quality finishes according to an exemplary embodiment of the invention.

### DETAILED DESCRIPTION OF THE INVENTION

The description set forth below as connected with the incorporated drawings are intended as a description of various embodiments of the disclosed subject matter and are not necessarily intended to represent any one select embodiment. In certain instances, the description can include specific details for purposes of providing an understanding of the disclosed embodiments. However, it will be apparent to those skilled in the art that the disclosed embodiments can be practiced without those specific details. In some instances, well-known structures and components can be shown in block diagram form in order to avoid obscuring concepts or design variations of the disclosed subject matter.

In the automotive field of vehicle lighting, manufacturers are seeking to improve light reflective performance by addressing the substrate surfaces of course, porous and irregular base layers of plastic based light reflective components. Such an irregular base layer is often fraught with undesirable surface features such as course graininess, voids, surface inclusions, waveform patterns, pitted dimples, micro inclusions, abrasions and porosity, etc. that inhibit the preferred factors and surface characteristics set for efficient reflector production. Effective reflector components highly depend on effectively smooth or smooth-as-glass surface conditions in order to effectively function to direct beams as controllably intended without straying errantly.

In the automotive field of vehicle lighting, automakers seek to improve coatings on automotive reflector surfaces to endure thermal resilience and possess refined smoothness to enhance light reflectivity in a controlled manner and enhance surface adhesion properties for metallization or material deposition integrated into lighting products that qualify performance for lighting and signaling functions. Automakers also desire these enhancements in a more cost effective way that translates beneficially to consumers and auto-makers for favorable satisfaction ratings, which can further enhance manufacturer brands.

Polymeric material or polymers commonly refer to as “plastics” are a substance made up of large molecules, which are formed by linking together smaller repeating units called monomers, essentially creating a long chain of molecules with a high molecular weight. Polymers can be flexible, rigid, strong, elastic, or have other diverse properties, giving the material unique properties based on its structure. Non-limiting polymers are described and can be any suitable type commensurate with this disclosure's purposes including repurposed plastics that might include fiber, glass or other associated constituents aggregates or fillers that generally come from recycled or waste plastics.

Polyurethane (referenced in the field as PU or PUR for abbreviated convenience) is a chemically manufactured plastic, which may be applied as a coating material. Polyurethane (PUR or PU) also refers to a class of polymers composed of organic units joined by carbamate (urethane) links. Polyurethane is produced from a wide range of starting materials-in contrast to other common polymers such as polyethylene and polystyrene. This advantage of PUR production from a wide range of starting materials provides an advantage and flexibility for producing PUR from an expansive list of choices. However a known drawback for pursuing PUR production is hindered by the consequence of releasing volatile organic compounds (VOC) into the environment from the type of solvents often used in PUR production, which is another reason PUR usage is avoided without a better way of restricting VOC byproducts.

Among existing problems with using recycled plastics or lower specific gravity grade plastics is that using such materials as a base substrate 2 for producing reflector components 10 has been an impractical or unfeasible task because it demands a concerted effort to remediate, smooth-out or blend-out the surface roughness μ before attaining a sufficient condition that allows reflective deposition or metallization 77 on the base substrate 2 to occur—not only for effective binding at the interface between substrate 2 and reflective composition 77 but to allow effectively good performance of a deposited reflector layer 77 that is suitably smooth enough to direct light rays without uncontrolled deviations stemming from errantly straying off undesirable substrate features or irregular surfaces. Moreover, current methods to address the mentioned undesirable surface features involve the consequence of releasing solvents of volatile organic compounds (VOC) into the environment that ordinarily comes from the surface preparation, polymerization and curing of film coatings 99 at the substrate surface 2 using existing methods. As such, taking steps to properly metallize or deposit reflective coatings 77 onto such a base plastic substrate 2 material becomes an impractical matter from the added complexity of requiring surface preparation just to get uncontrollable light scattering distribution after metallization 77. Such situations currently make reflective application to these kinds of defective plastics not feasible without a simpler solution.

Another particular enhancement that automakers demand is the reduction of byproduct contaminants released into the environment. The subject invention can accomplish this objective with the use of biodegradable solutions and the avoidance of outgassing from VOC (Volatile Organic Compound) in the production of PUR coatings 99 from existing usages with harmful solvents.

Among enhancement goals, automakers and customers demand structural features that will meet automotive lighting performance. Addressing low-grade surface finishes with coatings that can effectively transform reflector surfaces to upgraded light-transmissive rated parts in an inexpensive way can effectively contribute towards this endeavor. Along with this aspect to meet performance mandates, the improvements of adhesion performance between the reflective layer and the base layer's coating can avoid or effectively prevent delamination of areas that are susceptible to weathering or wear during the product's lifecycle, which can also contribute adverse risks to lighting performance expectations.

Among the enhancement goals for remediating lower-grade plastic base materials or substrates 2, automakers demand light reflective products 1 that will not introduce harmful byproducts into the environment and products that will remain resilient and extend the longevity without degradation of the reflective products 1 and maintain a condition of allowing peak performance of the automotive vehicle lighting products over its extended service life. It has been a persistent problem that PUR-based products are often soft as a base layer that is easily scratched and which adversely can influence beam performance reflectivity or can contribute to beam performance degradation while in service. To date, customers and manufacturers have resorted to chemical solvents, less environmentally friendly processes and costly methods for refurbishing reflector surfaces from low-grade plastics to be used in lighting devices that can hinder performance ratings. The defects within course surface finishes for reflectors of low-grade plastics renders lighting product performance inferior as compared to reflective surfaces with glossy or refinely smooth finishes.

Consequently, conventional limitations and practices present significant drawbacks against using repurposed scrap or low-grade plastics for meeting surface reflective product requirements. Accordingly in the automotive field, there's a need for repurposing waste products that can provide an inexpensive source of stock materials, which can be suitably rated for particular vehicle functions and performance while not adding waste to landfills or toxicity to the environment.

Accordingly in the automotive field, there has been a need for providing a better approach and methods to address such surface defects of low specific gravity plastics, lower-grade plastics or waste plastics (such as for reflector substrates, by non-limiting example) using resilient PUR compositions, which can facilitate a glossy surface base that would be ideal for a metallized deposition within a precision tolerance bed (sometimes referenced within layered thickness of 5 to 10 Angstroms) that can fulfill light reflective beam performance, remain environmentally sustainable and yet still meet the automotive field's sought after objectives. Stack-ups of PUR-based formulations can be within a pre-determined thickness [T] of between 7-20 microns (0.007-0.020 mm) consistently across the majority surface area [A] of the remediated substrate 2.

The inventors of this disclosure discovered that PUR-based coatings can be applied to lower specific gravity and lower grade plastics in a favorable way. The PUR-based coating system can be economically feasible by transforming the associated rough surfaces of such lower-grade plastics to a condition that qualifies surfaces that are fit for metallization and deposition of reflective compositions in a unique way. All the while also enhancing PUR-based formulations in production parts and keeping the release of significant volatile organic compounds (VOC) released as a byproduct kept to a minimum. Accordingly, the inventors have conceived systems where base plastics exhibiting surface deficiencies can be successfully tackled with the application of polyurethane-based (PUR) compositions for achieving elevated degrees of surface smoothness for light reflective purposes and automotive field products that can improve surface finishes for enhanced reflectivity characteristics.

In one embodiment, a PUR-based formulation coating can result with a thickness (T) of about 7 micron to 20 micron (0.007-0.020 mm). In an alternate embodiment, the PUR-based formulation can apply a thickness (T) value in a range between 8-12 microns (0.008-0.012 mm) for acceptable results

These polyurethane-based (PUR) formulations can be applied over defective irregular-surfaced substrates 2 or a majority surface area [S] of the plastic substrate 2 to enable refurbishment or remediation towards surfaces that are suitably smooth and consistent to function as a reflective surface area [S]. It is disclosed that an irregular-surfaced substrate 2 can be a reclaimed polymeric or thermoplastic material with all the fillers, aggregates, fibers and generally expected constituents from a recycled product. It is contemplated that the irregular-surfaced substrate material 2 can include a polycarbonate (PC) or polymethyl methacrylate (PMMA) or other similar reclaimed polymeric material as described.

Likewise, a majority surface area [S] of an irregular plastic substrate 2 can be remedially processed to provide a matte surface area [M] instead of a glossy smooth product specimen should one desire in the alternative. Described formulations of Polyurethane-based (PUR) compositions can extend to acrylic-urethane compositions (PUA), compositions that have Acrylic monomers derivable from an acrylic monomer formulation of esters of acrylic acid, such as methyl acrylate, ethyl acrylate, butyl acrylate, and 2-ethylhexyl acrylate. Described urethane-based formulations can also extend to suitably accessible oligomer compositions where an oligomer based formulation may be used in conjunction with a PUR-based composition to regulate flow viscosity within passages of the mold tool 40.

By implementing urethane coating chemistry (via thermal curing methods) through the in-mold process, the coating of an inferior low-grade plastic surface can be promoted to achieve a highly saturated degree of cross-link polymerization, which can substantially promote the surface smoothness and reflectivity of an applied inferior waste stock material placed in-mold after the thermal cure. It has been discovered that implementation of thermal curing means can achieve at least a range between 60% -80% crosslink polymerization to feasibly achieve reflector-grade surface smoothness with the PUR-based formulations. Thus given conventional curing technologies with repurposed plastics and with minimal preparation, one can directly apply PUR-based formulations onto irregular plastic surfaces without the involvement of additional treatment or chemical processes that'd adversely contribute to waste, harmful emissions and scrap rates.

In general, coatings are a covering of material of a particular composition applied onto the surface of an object or a substrate. The general purpose of applying the coating may be decorative, functional or a combination of both. Coatings can be applied in various states of matter inclusive of solid, liquid, gas or plasma (e.g. powder coatings). In the subject field of automotive lighting, coatings based on polyurethane-based (PUR) formulations have not possessed characteristics needed to perform resiliently in lighting products. Thus, limiting PUR application to non-lighting functions. Existing surface refinishing techniques for low-grade or irregular surface plastics by in-mold methods have remained deficient and have not achieved the smoothness characteristics required for reflector lighting production or performance that can satisfy requirements. However, recently developed PUR-based coating methods applied over such defective plastic surfaces can promote achieving this.

Generally much of the lower-grade or waste plastics possess irregular surface features to render them unsuitable for use as reflector substrates or smooth finished products even when repurposed. Conventional practices to rework or refurbish low-grade plastic surfaces applied in lighting products have led end users with limited options through costly production handling and treatments of harmful byproducts or special workarounds for making eligibly performing lighting devices. While such approaches can address the irregular surface issues that affect beam performance, customers and manufacturers are less inclined to incur the expenses of adopting production complications or more costly treatment formulations to the extent that beam patterns degrade or fall out of ideal performance.

Surface roughness as described for an irregular surface can generally be measured by Ra-value (μm) roughness scale, where for example: 0.8 μm Ra is generally considered a high-grade minimal roughness finish; Ra 1.6 μm can be considered a moderately smooth surface (often used in engine blocks, pump components or machine tools); Ra 6.3 μm can be considered relatively rough surface (often used in brake components, conveyor belts, or metal castings) and Ra 25 μm can be considered a very rough surface. Surface smoothness can alternatively be described as “surface smoothness (μ)” [Ra μm measurable value] as measured by Ra or Rz-value or another reasonably suitable standard.

In assessing whether a source material can be suitable as a reflector or a product 1 for light reflective purposes, one must assess the controllable smoothness for surface reflection of such material surfaces. Surface smoothness or surface reflection as described can generally be measured by the Distinctness of Image (DOI) standard. DOI is a measure of how sharp and clear a reflected image is, and is often used in the automotive industry to characterize the appearance of painted surfaces and coatings. The American Society for Testing and Materials (ASTM) has established industry standards for measuring Distinctness of Image (DOI) on a scale of 0 to 100. A DOI of 100 indicates a surface that reflects an image with perfect clarity, while a lower DOI indicates a blurry image. Surface reflection can alternatively also be described by “surface smoothness [μ]” value as measured by Ra or Rz-value or any reasonably suitable standard. In this disclosure, any suitable DOI value can be designed for establishing a sufficiently smooth PUR-based coat finish but inventor developmental efforts have established a preferred embodiment where cured coating layer 44 or remediated surface layer 88 can achieve a target value of 88 DOI for gloss finishes and a 20-25 DOI range value for matte finishes.

Recently developed coatings using urethane chemistry through in-mold production have rendered urethane based polymeric materials suitable for refurbishing irregular substrate surfaces by achieving surface smoothness [μ] of about Ra 0.4 μm (Ra-value) on a roughness scale along the majority surface area [S] of course finish repurposed plastic substrate 2. Irregular surface substrate values with at least Ra 6.3 μm have been process to achieve reflectivity values ranging between 78-92 DOI across the majority surface area [S] as measured by a lighting test through in-mold PUR-based formulations and associated remediation techniques. Such prospective coating development can be extended to automotive bezels or reflective surface applications while maintaining the attributes of an in-mold system to reduce waste, scrap and undesirable environmental emissions.

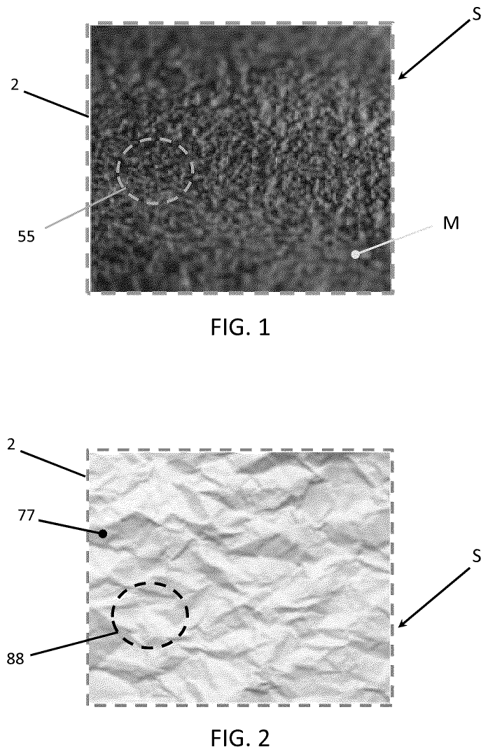

FIG. 1 is an illustration of existing defects along interfacial surfaces of low-gravity or low-grade substrate 2 exhibiting irregular surface roughness 55 characteristics. In FIG. 1, a typical low specific gravity or low-grade plastic rendered by an opaque substrate 2 is illustrated that exhibits a matte surface area M. The depicted reflective surface area S can clearly show that such a finish renders the substrate 2 unsuitable as a reflector or light reflective part by a minimal measure of Distinctness of Image (DOI), which represents surface smoothness by a surface reflection characteristic.

FIG. 2 is a depiction of smoothened surface result following a PUR coating remediation treatment applied on an irregular surface as in FIG. 1 akin to a polished steel tool surface according to the present invention. FIG. 2 illustrates a reflective surface coating 77 after a surface layer remediation 88 using a PUR-based composition is cured within a mold tool 40 and processed by thermal cure means 66.

PUR-based composition 10 with acrylic monomer composition 11 is formulated with reactive components 3 can be emplaced over the irregular surface roughness 55 of substrate 2 and then cured to enhance the surface smoothness of the substrate 2 to qualify as a reflective-rated product 1. Exposing substrate 2 with the PUR-based formulation to a thermal cure means 66 triggers polymerization and cross-linking 88 for hardening the PUR coating composition 99 resulting in a remediated surface layer 88 of the substrate 2.

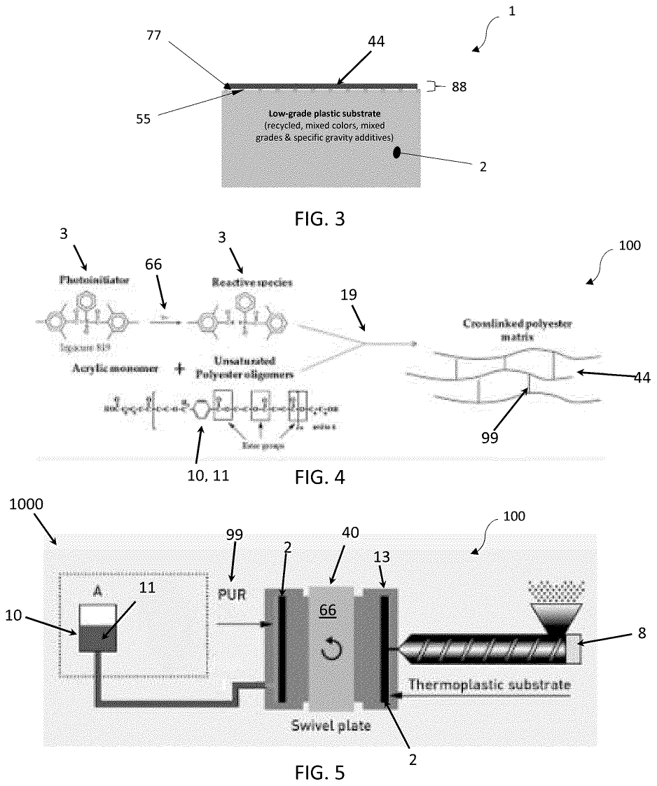

FIG. 3 is a cross-sectional illustration of a resultant product structure of a reflective component after application of PUR-based formulation to an irregular surface substrate according to the present invention. As illustrated in FIG. 3, a PUR-based composition 10 with acrylic monomer composition 11 formulated with stabilizers and additives and reactive components 3 can be deposited onto a substrate 2 with irregular surface roughness 55 within a mold tool 40. The mold tool 40 can include a preferred embodiment of a rotatable swivel arrangement with substrate material introduced by an operator into the mold tool sections or sourced from a polymeric feed mechanism 8 to facilitate production. However the in-mold tool arrangement should not necessarily be restricted to any particular arrangement and may use any feasible arrangement that can work equally well. The PUR-based formulation can include an uncured polymeric composition 10 with acrylic composition or oligomer materials 11, which can be sourced from number of chambers 13 associated with the mold tool 40 that provide the constituent compounds that can be pre-mixed, combined or metered together for deposit to the irregular-surfaced substrate 2 or injection into mold tool 40.

FIG. 5 depicts that each chamber 13 can source a constituent portion of the uncured polymeric composition 10, chemical additives, stabilizers, chemical reactants or solution 11. As illustrated, a constituent composition from each chamber 13 may be metered or regulated to a control valve or mixer 12 before being directed and deposited to an in-mold section 40, where each section 13 can be appropriately advanced at each stage of the process to receive substrate 20, receive a polyurethane (PUR) or Polyunsaturated aldehyde (PUA) based polymeric composition injection 10, undergo each respective cure and eject each product unit to complete PUR-based product 1.

FIG. 4 is an illustration of an in-mold PUR-based formulation process applied in remediating low-grade irregular-surfaced plastic substrates 2 according to the present invention. FIG. 4 depicts the material constituents of the PUR-based formulation by uncured composition 10 and acrylic composition 11 with reactive components 3 that may be combined to implement product system 100, which transforms the irregular-surfaced substrate 2 to have a remediated surface smoothness that qualifies reflector-rated performance. The thermal-cure means 66 within the mold tool can promote the PUR-based formulation to become a highly cross-linked PUR-based coating 99 that can result from the uncured PUR-based formulation of polymer composition 10 with acrylic composition 11 and reactive components 3 that are blended and first exposed to the thermal cure means 66 and to cure (cross-link) for the production of surface smooth coated substrates that possesses elevated degrees of cross-linked polymerization. A crucial aspect with the thermal cure process is that applying a non-stick coating (such as but not limited to fluoro-polymer compounds) to the mold tool surfaces to overcome the side-effects of volumetric shrinkage from the curing process can ensure consistent results to provide a smooth product release with the PUR-based formulation after curing. In an exemplary embodiment of the PUR-based formulation, it can be expected that volumetric shrinkage from the thermal in-mold curing process extends up to 15% for glossy surface finishes of cured coating layer 44. But that volumetric shrinkage from the thermal in-mold curing process can be on the order of up to 5% for matte surface finishes of cured coating layer 44.

FIG. 5 is a visual depiction of a single component polyurethane-urethane (PUR) formulation system of a reflective product 100 after thermal curing according to an embodiment of the invention.

FIG. 5 illustrates how the single component PUR-based formulation derived from polymer composition 10 and from reactive constituents 3 of a photo-initiator, acrylic monomer or acrylic composition 11 or unsaturated polyester oligomer materials can be combined in a thermal cure means 66 to thoroughly polymerize and complete cross-linking composition 99 at the coating's exposed surface 44 and further into the coating's depth. The thermal cured PUR composition 88 can result in a cross-linked matrix 99, as shown in FIG. 4.

In one embodiment illustrated in FIG. 5, a single component uncured PUR-based polymeric composition 10 and acrylic composition 11 with reactants 3 can be formulated with additives and stabilizers deposited onto an irregular-surfaced substrate 2 within a mold tool 40.

The mold tool 40 can include a preferred embodiment of a rotatable swivel arrangement having irregular-surfaced substrates 2 emplaced into the mold tool 40 to facilitate production. However this embodiment should not necessarily be restricted to any particular arrangement (as seen FIG. 5) and may use any feasible arrangement that can work equally well. The uncured PUR-based composition 10 and acrylic composition 11 with reactants 3 can be injected or transferred to a number of chambers 13 associated with the mold tool 40 that can provide the constituent compounds that may be pre-mixed, combined or blended together for deposit into the mold tool 40 and ultimately applied to the substrate 2.

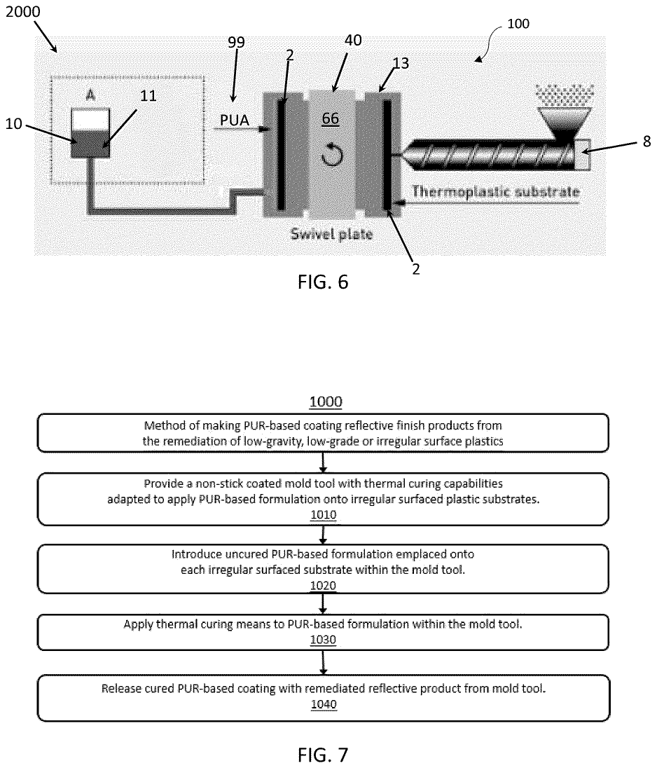

FIG. 6 is a visual depiction of a single component acrylic-urethane (PUA) formulation system of a reflective product after thermal curing according to an alternate embodiment of the invention.

FIG. 6 depicts an alternative embodiment PUR-based formulation where each chamber 13 is emplaced with an irregular-surfaced substrate 2 and can source a constituent portion of the uncured polymeric composition 10 and chemical reactants (chemical reactants or solution 11 with chemical additives, stabilizers) from segregate sources like separate vats for each component. As illustrated, a constituent composition from each chamber 13 may be metered or regulated into the mold tool 40 before being directed and deposited to an in-mold section 13, where each section 13 can be appropriately advanced at each stage of the process to receive substrate 2, receive a PUR-based composition injection 10 and acrylic composition 11, and can undergo a thermal cure means 66 to remediate each irregular-surfaced substrate 2 and eject each completed reflector surface product 100. And as a point of material significance, the PUR-based formulation can incorporate an aspect of applying a non-stick coating to the mold tool surfaces to overcome the side-effects of volumetric shrinkage from the curing process. Again one can expect for embodiments of the PUR-based formulation that volumetric shrinkage from the thermal in-mold curing process should not exceed 15% for glossy surface finishes of cured coating layer 44. But that volumetric shrinkage from the thermal in-mold curing process should be less than 5% for matte surface finishes of cured coating layer 44.

FIG. 7 illustrates a method 1000 of making polyurethane-based (PUR) coated products by remediating lower-grade irregular surface plastics into surfaces of reflective quality finishes according to an exemplary embodiment of the invention. In method 1000, an uncured formulation of PUR-based polymeric composition is provided with UV stabilizers, additives and chemical reactants, which are emplaced onto low-gravity or low-grade plastic exhibiting irregular surface characteristics within a non-stick surface coated mold tool. In method 1000, constituent elements of UV stabilizers, additives and chemical reactants are combined to form the PUR-based formulation derived from a single component source chamber transferred to the mold tool. The method 1000 also provides a non-stick coating surfaced mold tool with thermal curing capabilities and provides a feed mechanism for directing polymeric material to the mold tool. Method 1000 can incorporate a critical aspect of applying non-stick coating (such as but not limited to fluoro-polymer compounds) to the tooling surfaces to address volumetric shrinkage occurring from the thermal cure process. Volumetric shrinkage of a remediated surface layer or a cured coating layer of the PUR-based formulation should be expected to not exceed 15% for glossy surface finish embodiments after thermal in-mold curing. But that volumetric shrinkage should be less than 5% for matte surface finishes of a remediated surface layer or cured coating layer after the thermal in-mold curing process. In method 1000, steps to provide an uncured formulation of PUA-based polymeric composition from a single component source with acrylic composition or unsaturated polyester oligomer materials, UV stabilizers, additives and chemical reactants are delivered to the mold tool having low-grade substrates with irregular surfaces in order to remediate and enhance surfaces to a PUR-based coated product that can perform as a reflective quality product.

In block method 1010, a non-stick surface coated mold tool associated with a number of sections and thermal curing capability is provided along with logistics for receiving polymeric feed material and introducing irregular-surfaced substrates from low-grade or low-specific gravity plastics.

In block 1020, an uncured formulation of PUR-based polymeric composition with UV stabilizers, additives and chemical reactants are emplaced onto each irregular surface substrate within the mold tool. In a non-limiting way, the mold tool can represent exterior and interior mold sections and can transfer mass between the number of constituent chambers or partitions of a product at various stages of the process.

In block 1030, a thermal curing means can be applied to each uncured PUR-based formulation having an emplaced irregular-surface substrate within the mold tool. In block 1040, a remediated substrate with enhanced surface smoothness as a reflective rated product can be derived from the fully cured PUR formulation of each emplaced substrate and can be released by the non-stick coated mold tool.

The methods 1000 and 2000 illustrate sample embodiments of the production process with the PUR or PUA based automotive reflective products that form surface remediated smoothened product characteristics and conform to automotive regulatory requirements. Therefore, lighting performance is qualified and enhanced while satisfying market demands with more environmentally friendly manufactured products.

Among the various embodiments, two blocks shown in succession may in-fact be executed substantially concurrently or the associated blocks may sometimes be executed in the reverse order, depending upon the functionality involved, by non-limiting example. It will also be noted that each block of the block diagrams or in the flowchart illustrations or of blocks in the block diagrams or flowchart illustrations, can be implemented by both manual or automated systems that perform the specified functions, or by actions can carry out combinations of special purpose hardware and by control instructions.

With the development of PUR-based coatings, reflective particles can be embedded into or made a part of the coating formulation or applied as a metalized-metallic compound processed over the coating. A “reflective particle(s)” is described as a tiny particle that readily bounces back light when it hits a surface, essentially acting like a small mirror, reflecting a significant portion of the incident light that strikes the particle. Reflective materials or PUR formulations as described by this disclosure can adopt this phenomenon when incorporated into the described material components or lighting structure like metallic particles or specially designed microspheres or forms used in the described coatings or formulations. And as disclosed, metallic compounds can be described as a material containing aluminum, stainless steel, silver or some suitably derived alloy from some combination of the described. Reflective materials by this disclosure can also extend to describe “reflective white” compounds that can include reflective pigments reflective white thermosets or other suitably reflective polymeric coatings.

The inventive results associated with the PUR-based remediated reflector product 1 can include a hardcoat or sealcoat along the coating's exterior surface layer. A sealcoat can represent a protective topcoat against weathering, contaminants and degradation. The sealcoat can preferably be a polyurethane-based material or can be another sealant material. The sealcoat can be applied along a side of the cured coating either directly or indirectly and can be overlaid with other intermediate constituents (i.e. patterned film sections). The sealcoat can be applied by any means such as spray, manual or mechanical application, or through dipping by non-limiting examples.

It is to be understood that terms such as “front,” “rear,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, and/or points of reference as disclosed herein, and likewise do not necessarily limit embodiments of the present disclosure to any particular configuration or orientation.

Furthermore, the terms “about,” “approximately,” “proximate,” “minor” and similar terms generally refer to ranges that include the identified value within a margin of 20 percent, 10 percent or preferably 5 percent in certain embodiments or any values therebetween. In this text, the term “comprises” and its derivations (such as “comprising”, etc.) should not be understood in an excluding sense, that is, these terms should not be interpreted as excluding the possibility that what is described and defined may include further elements, steps, etc.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of or even consists of the elements, ingredients, components or steps

Certain recitations contained herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. The claimed expression “a number of . . . ” is to be construed to mean or represent “one or more” in countable number such that the expression can represent a singular or multiple number of recited unit elements.

An automotive lighting product is intended indifferently to mean an exemplary exterior light, a front or rear vehicle light or a lighting module or interchangeably can also be called a headlamp or headlight. As is known, an automotive lighting product can serve as a vehicle's external light having a lighting or signaling function directed towards the outside of the vehicle. The lighting product can potentially serve for signaling as a position light, a direction or turn indicator light, daytime running light (DRL), a brake light, a fog light, a reversing light, a low-beam headlight, a high-beam headlight or some combination thereof by way of example.

It should be appreciated that the above referenced aspects and examples are non-limiting, as others exist within the present invention as shown and described herein. Unless stated otherwise, dimensions and geometries of the various structures depicted herein are not intended to be restrictive of the invention such that other dimensions or geometries are possible. Plural structural components can be provided by a single integrated structure. Alternatively, a single integrated structure might be divided into separate plural components.

In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

### LIST OF ELEMENT NUMBERS

PUR Light Reflective Product 1
Opaque Plastic Substrate 2
Reactive Components 3
Polymeric Feed Mechanism 8
Uncured Coating Composition 10
Acrylic Monomer Composition 11
Mold Tool Section 13
Outgassing byproduct 19
Major surface area of plastic substrate S
Matte surface area M
Thickness value T
Smoothness measure μ [Ra μm value; Ra or Rz-value out of 0-100 benchmark]
Mold Tool 40
Cured coating layer 44
Irregular surface roughness 55
Thermal cure means 66
Reflective Layer Coating Composition 77
Remediated Surface Layer 88
PUR Coating Composition 99
PUR based Product System 100
Method to make PUR light reflective product 1000
Method to make PUA light reflective product 2000

1. A light-reflective product formed from an in-mold process comprising:
a plastic substrate of an opaque medium that is configured to block light through the plastic substrate, where the plastic substrate has a number of surface imperfections described by an irregular surface as measured by a roughness value [μ] along a majority surface area [S];
a layer of urethane-based composition (PUR) applied along a majority surface area [S] of the plastic substrate that is configured to fill the number of surface imperfections for enhancing a surface smoothness by a measure of Distinctness of Image (DOI) along the majority surface area [S];
a layer of reflective material deposited over the layer of urethane-based composition; and
the layer of reflective material resulting in the surface smoothness of about 78 DOI as a surface reflection value.

2. The light-reflective product of claim 1, wherein the reflective material includes a metallic compound.

3. The light-reflective product of claim 1, wherein the reflective material includes a polymeric compound embedded with reflective particles.

4. The light-reflective product of claim 1, wherein the PUR-based composition can be derived from polyol and isocyanate compounds.

5. The light-reflective product of claim 1, wherein the number of surface imperfections encompasses one or more features of: grainy protrusions, voids, wavy forms, pitted dimples, micro inclusions, surface abrasions, porous features or surface inclusions.

6. The light-reflective product of claim 1, wherein the reflective layer with a predetermined thickness [T] overlays a PUR-based coating thickness value [T] of between 7- 20 microns (0.007-0.020 mm) consistently across the majority surface area [S] of the plastic substrate.

7. The light-reflective product of claim 1, wherein the light reflective product achieves a reflectivity value of at least 82 DOI with consistency as measured across the majority surface area.

8. The light-reflective product of claim 1, wherein the number of surface imperfections reside specifically along an exterior surface of the plastic substrate on a same side as a reflecting light source.

9. The light-reflective product of claim 1, wherein the PUR-based composition is an acrylic-urethane (PUA) formulation.

10. The light-reflective product of claim 1, wherein the PUR-based composition is used in conjunction with an oligomer based formulation configured to regulate flow viscosity.

11. The light-reflective product of claim 1, wherein the PUR-based composition is derived from an acrylic monomer formulation of esters.

12. The light-reflective product of claim 1, wherein the PUR-based composition is configured to include reflective particles of a metallic compound for an alternate formulation.

13. The light-reflective product of claim 1, wherein the reflective layer is applied over a pre-determined thickness [T] of the PUR-based composition.

14. An automotive light-reflector formed from an in-mold process comprising:
a plastic substrate of an opaque substrate medium, where the plastic substrate has a number of surface imperfections described by an irregular surface as measured by a roughness value of Ra 6.5 μm;
a layer of urethane-based (PUR) composition in a fully cured condition applied with a pre-determined thicknesses [T] along a majority surface area [S] of the plastic substrate that is configured to fill the surface imperfections for enhancing the surface smoothness [μ] along the majority surface area [S];
a layer of reflective material applied with a pre-determined thickness [T] of between 7-20 microns (0.007-0.020 mm) consistently across the majority surface area [S] of the plastic substrate resulting in a surface reflection value of at least 78 DOI consistently across the majority surface area [S].

15. A method of making a light-reflective product from an in-mold process comprising:
presenting a plastic substrate of an opaque medium where the plastic substrate has a number of surface imperfections as measured by a roughness value of between Ra 1.6 μm to Ra 2.5 μm (roughness scale Ra-value);
applying a layer of a urethane-based composition (PUR) along a majority surface area [S] of the plastic substrate such that the urethane-based composition fills the surface imperfections to such an extent as to achieve a surface smoothness [μ] of about Ra 0.4 μm (roughness scale Ra-value) along the majority surface area [S];
applying a layer of reflective material with a predetermined thickness [T] over the layer of PUR-based composition;
obtaining a reflectivity value range of between 82-92 DOI consistently across the majority surface area [S] as measured by a lighting test; and
removing the light-reflective product from an in-mold process and incorporating the light-reflective product into a lighting system.

16. The method of making a light-reflective product of claim 15, wherein the coating layer maintains the surface reflection value of at least 76 DOI.

17. The method of making a light-reflective product of claim 15, wherein the coating layer maintains the surface reflection value of about 78 DOI.
